(19) United States
(12) Patent Application Publication
(10) Pub. No.: US 2026/0298010 A1
(43) Pub. Date: Oct. 1, 2026

(54) POWER SWING DOOR WITH CHAIN DRIVE

(71) Applicant: STRATTEC POWER ACCESS LLC, Auburn Hills, MI (US)

(72) Inventors: Gregory V. Sproule, Linden, MI (US); Kimpon Ngem, Grant Township, MI (US); Richard Crandall, Fenton, MI (US); Howard W. Kuhlman, Clarkston, MI (US); Curtis A. Braun, Lake Orion, MI (US); Jacob D. Fritschle, Rochester Hills, MI (US); Srinivas J. Rao, Mono (CA)

(21) Appl. No.: 19/554,911

(22) Filed: Mar. 3, 2026

Related U.S. Application Data
(60) Provisional application No. 63/781,779, filed on Apr. 1, 2025.

(51) Int. Cl. E05F 15/627

(52) U.S. Cl. CPC E05F 15/627; E05Y 2201/64; E05Y 2201/668; E05Y 2201/686; E05Y 2201/716; E05Y 2900/531

(57) ABSTRACT

A chain drive for a power swing door on a vehicle includes a housing defining a track, and a chain disposed at least partially within the housing. The chain includes a first terminal end and a second terminal end. The chain drive further includes a carrier configured to slide linearly along the track. The first terminal end of the chain is coupled to the carrier and the second terminal end of the chain is coupled to the carrier, such that the chain and the carrier together form a closed loop. The chain drive further includes an actuator coupled to the chain to drive rotation of the closed loop, and a linkage having a first, proximal end coupled to the carrier and a second, distal end configured to be moved linearly toward and away from the housing via movement of the carrier along the track.

### CROSS-REFERENCE TO RELATED APPLICATIONS

This application claims priority to U.S. Provisional Application No. 63/781,779, filed Apr. 1, 2025, the entire contents of which are incorporated herein by reference.

### FIELD

This disclosure relates generally to doors on vehicles, including power swing doors on motor vehicles that are actuated via an actuator.

### SUMMARY

In one aspect, the disclosure provides a chain drive having a housing defining a track, and a chain disposed at least partially within the housing. The chain includes a first terminal end and a second terminal end. The chain drive further includes a carrier configured to slide linearly along the track. The first terminal end of the chain is coupled to the carrier and the second terminal end of the chain is coupled to the carrier, such that the chain and the carrier together form a closed loop. The chain drive further includes an actuator coupled to the chain to drive rotation of the closed loop, and a linkage having a first, proximal end coupled to the carrier and a second, distal end configured to be moved linearly toward and away from the housing via movement of the carrier along the track.

In another aspect, the disclosure provides a chain drive having a housing defining a track, a chain disposed at least partially within the housing, a carrier coupled to the chain and configured to slide linearly along the track, an actuator coupled to the chain to drive rotation of the chain, and a linkage having a first, proximal end coupled to the carrier and a second, distal end configured to be moved linearly toward and away from the housing via movement of the carrier along the track. The chain drive further includes a ball-shaped shaped interface member coupled to both the linkage and the carrier and positioned between the linkage and the carrier.

Other aspects of the disclosure will become apparent by consideration of the detailed description and accompanying drawings.

### BRIEF DESCRIPTION OF THE DRAWINGS

FIG. 1 is a schematic view of a vehicle having a power swing door and a chain drive according to one example.

FIG. 2 is a side view of the chain drive for the power swing door, illustrating a linkage in a retracted position.

FIG. 3 is a side view of the chain drive for the power swing door, illustrating the linkage in an extended position.

FIG. 4 is a partial cross-sectional side view of the chain drive, illustrating a carrier that is coupled to the linkage and is driven by a chain and motor assembly.

FIG. 5 is a partial cross-sectional side view of a chain drive according to another example for use with the power swing door.

FIG. 6 is an enlarged, partial cross-sectional side view of a ball-shaped interface member of the chain drive of FIG. 5, the ball-shaped interface member coupled to both a carrier and a linkage.

FIG. 7 is a perspective, partial cross-sectional view of the chain drive of FIG. 5.

### DETAILED DESCRIPTION

Before any examples of the present disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways.

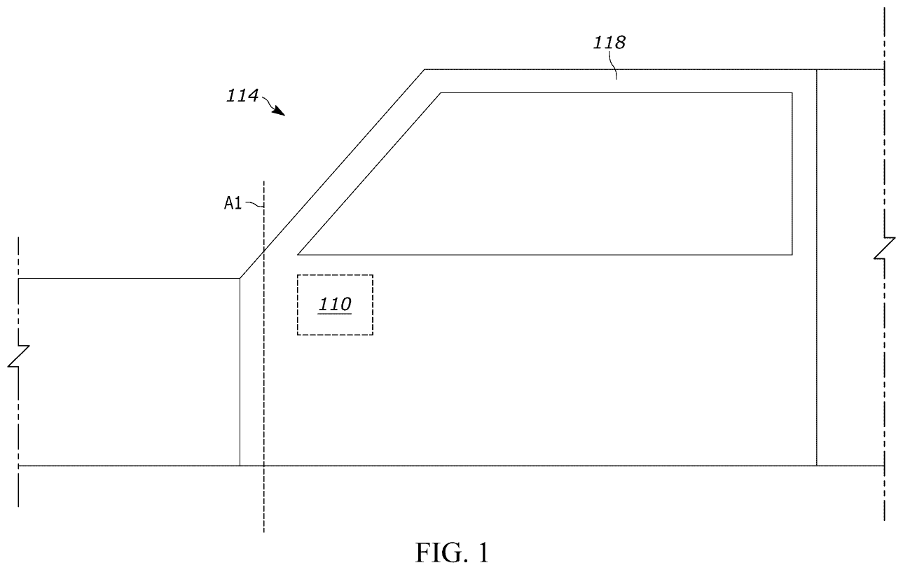

FIGS. 1-4 illustrate a chain drive 110 for use on a motor vehicle. The chain drive 110 may be used, for example for a power swing door on a motor vehicle, or for any other moving (e.g., pivoting) component on a motor vehicle or other structure. The chain drive 110 may include, for example, one or more motors, gears, clutches, sensors, couplers, tracks, carriers, and/or linkages to power the movement of the power swing door.

With reference to FIG. 1, in the illustrated example the chain drive 110 forms part of an overall motor vehicle 114, and is coupled to a power swing door 118 (e.g., a driver side door, a passenger side door, or other power swing door) of the motor vehicle 114. The power swing door 118 pivots about an axis A1 (e.g., a vertical hinge axis), and the chain drive 110 is used to drive a pivoting motion of the power swing door 118 about the axis A1. The chain drive 110 may be located, for example, in what is commonly referred to as a check-link area of the motor vehicle 114, wherein the check-link is replaced with the chain drive 110. In other examples, the chain drive 110 may be located elsewhere on or within the motor vehicle 114.

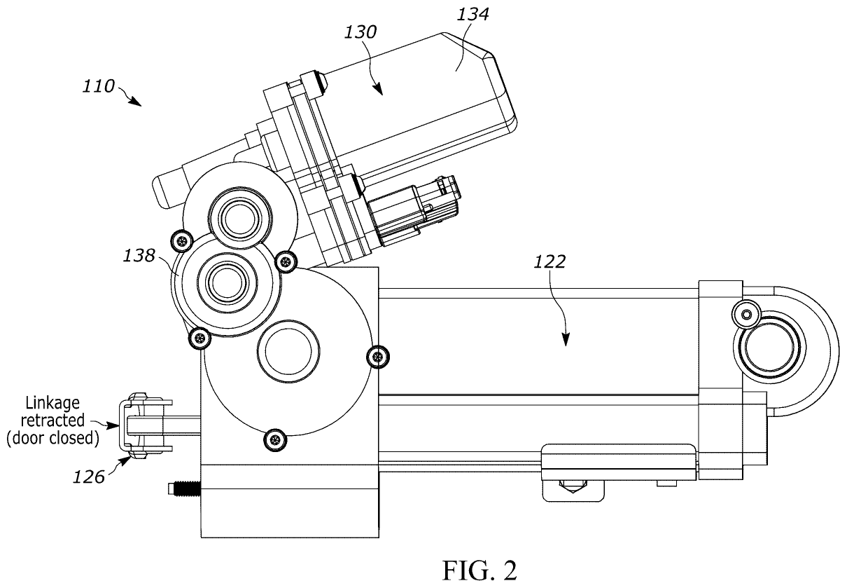

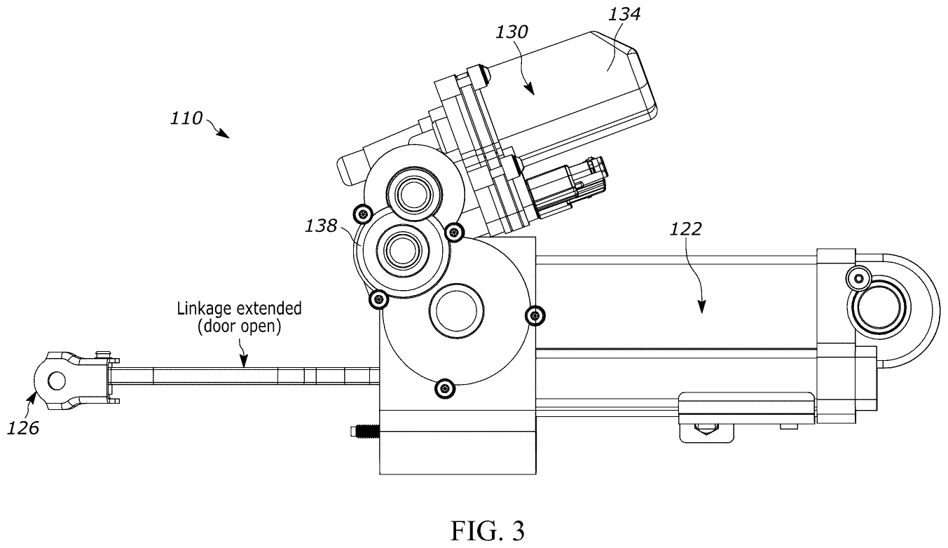

With reference to FIGS. 2 and 3, the chain drive 110 includes a housing 122 and a linkage 126 coupled to the housing. The linkage 126 is movable relative to the housing 122 for example between a first, retracted position (FIG. 2) and a second, extended position (FIG. 3). In the first, retracted position the power swing door 118 may be in a closed position, and in the second, extended position the power swing door 118 may be in an open position. In other examples, various other positions and/or orientations of the linkage 126 may be used to move the power swing door 118 between various positions (e.g., an open position, a closed position, a partially-open position, etc.). Additionally, in other examples, the linkage 126 may have other shapes and/or sizes than that illustrated, and/or may include a combination of multiple linkage elements that are linked together as opposed to a single linkage element.

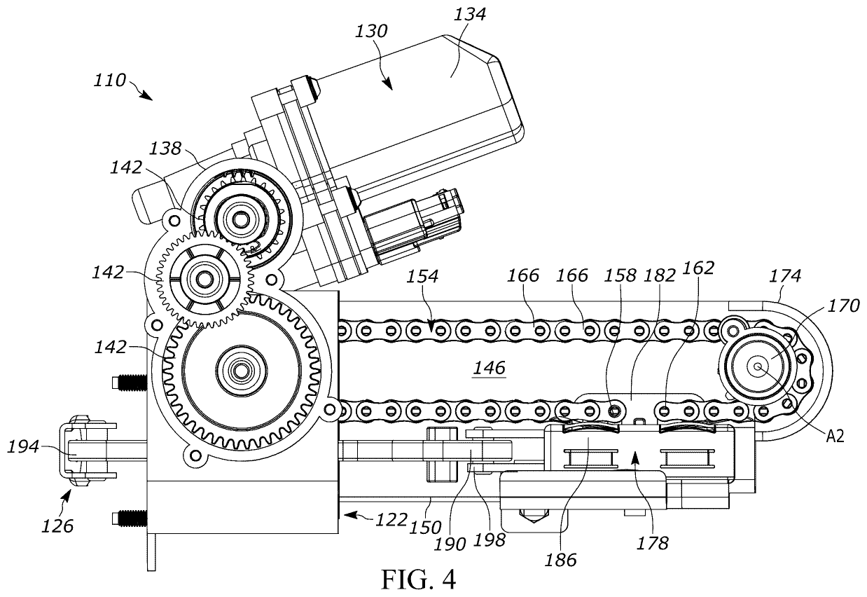

With continued reference to FIGS. 2 and 3, the chain drive 110 additionally includes an actuator 130 that drives movement of the linkage 126 relative to the housing 122 (e.g., between the closed position and the open position). In the illustrated example, the actuator 130 is coupled to a top of the housing 122, although in other examples the actuator 130 may be coupled to any other location of the housing 122, or may otherwise be located in a position other than that illustrated. The actuator 130 may include any type of actuator (e.g., an electric motor, a pneumatic actuator, a hydraulic actuator, etc.), and may include various components such as gear assemblies, clutches, etc. In the illustrated example, the actuator 130 includes an electric motor 134 and a gear assembly 138 coupled to the motor 134, having sprockets 142 (FIG. 4).

With reference to FIG. 4, in the illustrated example the housing 122 defines an interior space 146, and a track 150. The track 150 is located within the interior space 146, along a bottom of the housing 122, although in other examples at least a portion or portions of the track 150 may be located outside of the interior space 146, and or at other locations on or within the housing 122 than that illustrated. In some examples, the track 150 includes a lower surface that defines the interior space 146, and/or a side surface or surfaces that define the interior space 146, and/or is a rail or other structure located within the interior space 146 and/or at least partially defining the interior space 146 that facilitates guiding of a carrier (such as the carrier 178 described further below) within the interior space 146. In some examples, the track 150 is defined partially or entirely by the interior space 146 itself and/or the surfaces or structure that define the interior space 146. Other examples may include various other arrangements of surfaces or structures that define a track.

With continued reference to FIG. 4, the chain drive 110 further includes a chain 154 disposed at least partially within the housing 122. The chain 154 includes a first terminal end 158 and a second terminal end 162. The chain 154 may be formed, for example, from individual links 166 (e.g., metal links) that are coupled together.

As illustrated in FIG. 4, the chain drive 110 includes an idler 170 that rotates about an axis of rotation A2 (e.g., extending perpendicularly out of the page in FIG. 4). In some examples, the chain drive 110 may include an endcap 174 that is positioned over the idler 170. The chain 154 is positioned within the housing 122 such that the chain 154 wraps around the idler 170, and is driven to rotate about the idler 170 by the set of sprockets 142. Other examples may include other numbers and arrangements of sprockets and/or idlers for controlling the positioning and/or movement of the chain 154. Some examples may not include an endcap 174. Additionally, in some examples one or more of the sprockets 142 and/or the idler 170 may be over-molded (e.g., to dampen noise).

With continued reference to FIG. 4, the chain drive 110 additionally includes a carrier 178 that slides (e.g., linearly) along the track 150 within the housing 122. The first terminal end 158 of the chain 154 is coupled (e.g., fixed) to the carrier 178 and the second terminal end 162 of the chain 154 is also coupled (e.g., fixed) to the carrier 178, such that the chain 154 and the carrier 178 together form a closed loop within the housing 122.

As illustrated in FIG. 4, the first terminal end 158 of the chain 154 is spaced from the second terminal end 162 of the chain 154 by a gap, such that the first terminal end 158 is not in contact with the second terminal end 162. In the illustrated example, the carrier 178 includes an upper body 182, and the first terminal end 158 of the chain 154 is fixed to a first region of the upper body 182, and the second terminal end 162 of the chain 154 is fixed to a second region of the upper body 182.

With continued reference to FIG. 4, the carrier 178 also includes a lower body 186 coupled (e.g., fixed) to the upper body 182 (e.g., by being integrally formed as a single piece with the upper body 182, or formed as a separate piece and attached via a fastener, welding, etc. to the upper body 182, or otherwise coupled to the upper body 182). In the illustrated example the lower body 186 is positioned below the chain 154, and is sized and shaped and positioned to slide (e.g., linearly) along the track 150.

The chain 154, the carrier 178, and/or the track 150 may be sized and shaped such that the carrier 178 has a limited rotational degree of freedom within the track 150. For example, and as described above, the first terminal end 158 of the chain 154 may be spaced from the second terminal end 162 of the chain 154 by a gap, such that the first terminal end 158 is not in contact with the second terminal end 162. The chain 154 itself may include links 166 (e.g., at the first terminal end 158 and the second terminal end 162) that may rotate relative to the carrier 178. Accordingly, the carrier 178 may be permitted to rotate at least slightly within a plane (e.g., a vertical plane that is perpendicular to an axis of rotation A2 of the idler 170, or other plane).

With continued reference to FIG. 4, the carrier 178 may additionally or alternatively have a limited rotational degree of freedom with respect to the linkage 126. For example, the linkage 126 may include a first, proximal end 190 coupled to the carrier 178 and a second, distal end 194 that is moved linearly toward and away from the housing 122 via movement of the carrier 178 along the track 150. The chain drive 110 may include an interface member 198 (e.g., a ball-shaped interface member or other shaped member) that permits a limited rotational movement of the carrier 178 relative to the linkage 125 (e.g., in the same vertical plane and/or a different plane).

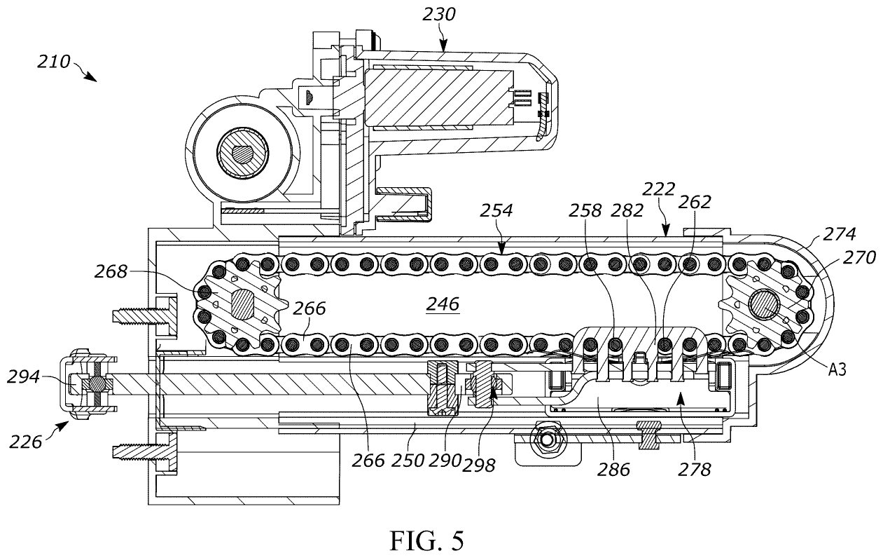

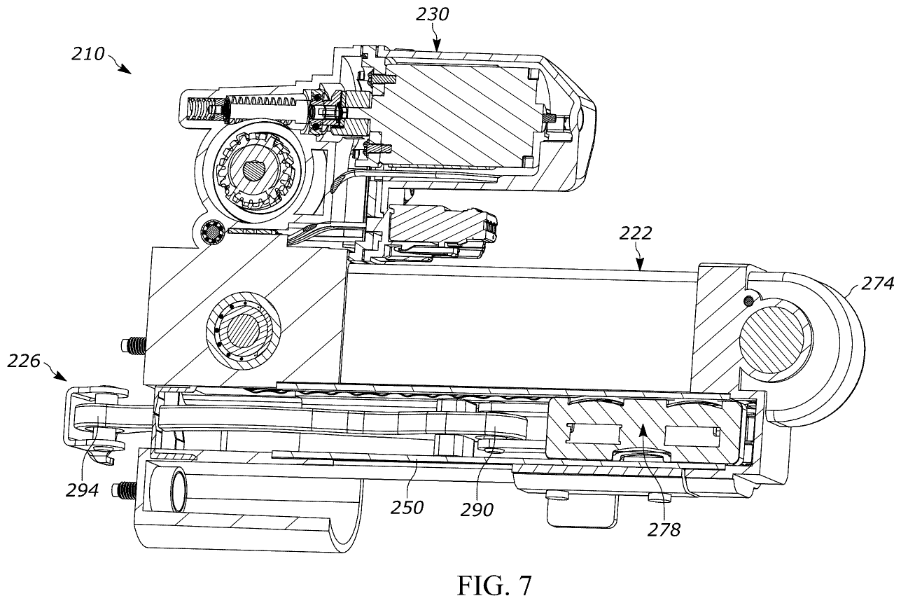

FIGS. 5-7 illustrate another example of a chain drive 210. The chain drive 210 is similar to the chain drive 110. Accordingly, one or more components of the chain drive 210 may be similar or identical to one or more components of the chain drive 110. In various examples, one or more components of the chain drive 110 may be replaced with one or more components of the chain drive 210, and vice versa.

As illustrated in FIG. 5, the chain drive 210 includes a housing 222, and a linkage 226 coupled to the housing. Similar to the linkage 126 described above, the linkage 226 is movable relative to the housing 222 for example between a first, retracted position and a second, extended position. The chain drive 210 additionally includes an actuator 230 that drives movement of the linkage 226 relative to the housing 222 (e.g., between the closed position and the open position). Similar to the actuator 130 described above, the actuator 230 may include any type of actuator (e.g., electric motor, pneumatic actuator, hydraulic actuator, etc.), and may include various components such as gear assemblies, clutches, etc.

With continued reference to FIG. 5, the housing 222 defines an interior space 246, and a track 250. The track 250 is located within the interior space 246, along a bottom of the housing 222, although in other examples at least a portion or portions of the track 250 may be located outside of the interior space 246, and or at other locations on or within the housing 222 than that illustrated. In some examples, the track 250 includes a lower surface that defines the interior space 246, and/or a side surface or surfaces that define the interior space 246, and/or is a rail or other structure located within the interior space 246 and/or at least partially defining the interior space 246 that facilitates guiding of a carrier (such as the carrier 278 described further below) within the interior space 246. In some examples, the track 250 is defined partially or entirely by the interior space 246 itself and/or the surfaces or structure that define the interior space 246. Other examples may include various other arrangements of surfaces or structures that define a track.

The chain drive 210 further includes a chain 254 disposed at least partially within the housing 222. The chain 254 includes a first terminal end 258 and a second terminal end 262. The chain 254 may be formed, for example, from individual links 266 (e.g., metal links) that are coupled together.

As illustrated in FIG. 5, the chain drive 210 includes a drive sprocket 268 (coupled for example to the actuator 230) and an idler 270 that rotates about an axis of rotation A3 (e.g., extending perpendicularly out of the page in FIG. 5), and may include for example an endcap 274 positioned over the idler 270. The chain 254 is positioned within the housing 222 such that the chain 254 wraps around the drive sprocket 268 and the idler 270, and is driven to rotate about the idler 270. Other examples may include other numbers and arrangements of sprockets and/or idlers, for controlling a positioning and/or movement of the chain 254. Some examples may not include an endcap 274. Additionally, in some examples one or more of the drive sprocket 268 and/or the idler 270 may be over-molded (e.g., to dampen noise).

With continued reference to FIG. 5, the chain drive 210 additionally includes a carrier 278 that slides (e.g., linearly) along the track 250 within the housing 222. Similar to the chain 154 described above, the first terminal end 258 of the chain 254 is coupled (e.g., fixed) to the carrier 278 and the second terminal end 262 of the chain 254 is also coupled (e.g., fixed) to the carrier 278, such that the chain 254 and the carrier 278 together form a closed loop within the housing 222.

The first terminal end 258 of the chain 254 is spaced from the second terminal end 262 of the chain 254 by a gap, such that the first terminal end 258 is not in contact with the second terminal end 262. In the illustrated example, the carrier 278 includes an upper body 282, and the first terminal end 258 of the chain 254 is fixed to a first region of the upper body 282, and the second terminal end 262 of the chain 254 is fixed to a second region of the upper body 282.

With continued reference to FIG. 5, the carrier 278 also includes a lower body 286 coupled (e.g., fixed) to the upper body 282 (e.g., by being integrally formed as a single piece with the upper body 282, or formed as a separate piece and attached via a fastener, welding, etc. to the upper body 282, or otherwise coupled to the upper body 282). In the illustrated example the lower body 286 is positioned below the chain 254, and is sized and shaped and positioned to slide (e.g., linearly) along the track 250.

The chain 254, the carrier 278, and/or the track 250 may be sized and shaped such that the carrier 278 has a limited rotational degree of freedom within the track 250. For example, and as described above, the first terminal end 258 of the chain 254 may be spaced from the second terminal end 262 of the chain 254 by a gap, such that the first terminal end 258 is not in contact with the second terminal end 262. The chain 254 itself may include links 266 (e.g., at the first terminal end 258 and the second terminal end 262) that may rotate relative to the carrier 278. Accordingly, the carrier 278 may be permitted to rotate at least slightly within a plane (e.g., a vertical plane that is perpendicular to an axis of rotation A3 of the idler 270, or other plane).

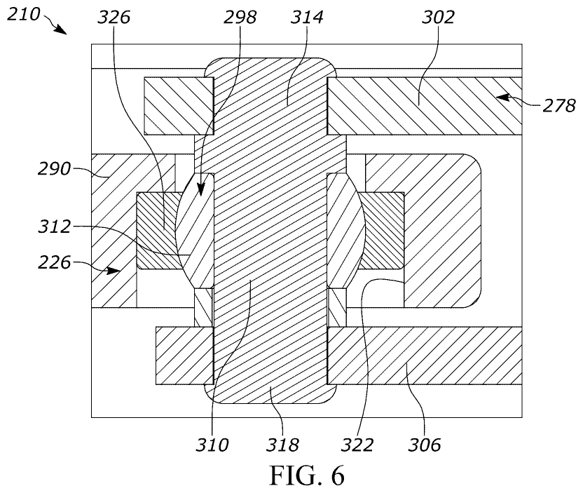

With continued reference to FIGS. 5 and 6, the carrier 278 may additionally or alternatively have a limited rotational degree of freedom with respect to the linkage 226. For example, the linkage 226 may include a first, proximal end 290 coupled to the carrier 278 and a second, distal end 294 that moves linearly toward and away from the housing 222 via movement of the carrier 278 along the track 250. The chain drive 210 may include an interface member 298 (e.g., a ball-shaped interface member or other shaped member) that permits a limited rotational movement of the carrier 278 relative to the linkage 226 (e.g., in the same vertical plane and/or a different plane).

With reference to FIG. 6, in the illustrated example the lower body 286 of the carrier 278 includes an upper plate 302 and a lower plate 306 spaced from the upper plate 302 by a gap. The interface member 298 may be at least a partially ball-shaped shaped interface member coupled to both the linkage 226 and the carrier 278, and may be positioned between the linkage 226 and the carrier 278 to permit a limited rotational movement of the carrier 178 relative to the linkage 226.

With continued reference to FIG. 6, in some examples the interface member 298 may be a rivet having a central region 310, an upper region 314 that is fixed to upper plate 302, and a lower region 318 that is fixed to the lower plate 306. As illustrated in FIG. 6, the first, proximal end 290 of the linkage 226 may include an aperture 322 that receives the central region 310. In the illustrated example, the interface member 298 further includes a ball-shaped region 312 that is coupled to and at least partially surrounds the central region 310. In some examples, the ball-shaped region 312 is formed of a different material than the central region 310, the upper region 314, and/or the lower region 318. In some examples, the central region, 310, the upper region 314, and/or the lower region 318 are formed of a same material. In some examples, the ball-shaped region 312 is formed of a same material as the central region 310 and/or is integrally formed as a single piece with the central region 310. Other examples may include other regions and/or arrangements of regions.

In some examples, a bushing 326 or other structure may be positioned within the aperture 322, and may further receive the ball-shaped region 312, while permitting limited rotational movement of the ball-shaped region 312. Other examples may include other shapes, sizes, and arrangements of an interface member 298 than that illustrated, and may include or not include the use of a bushing 326 or other structure.

Overall, a chain drive such as the chain drive 110 or the chain drive 210 described above (or other chain drives), may provide relative rotational degrees of freedom of its carrier and/or linkage, such that stresses imparted on the chain drive (e.g., an abusive slamming event of a door) do not lock up the chain drive and/or otherwise damage any components of the chain drive. For example, and as described above, a chain drive may include a connection of chain links to the carrier (e.g., via the first and second terminal ends of a chain as described above) that permits some limited rotational movement of the carrier. Additionally, or alternatively, the chain drive may include an interface member (e.g., a ball-shaped or other shaped interface member like that described above) that permits some limited rotational movement of a linkage relative to a carrier.

This is in contrast, for example, to other types of traditional linear actuators (e.g., leadscrew types of drives) where a connection point of a linkage may be offset from a center of a leadscrew and a leadscrew nut assembly, and where an offset loading (e.g., an abusive slamming event) may cause a locking up the leadscrew and nut. In such drives, the linkage may exert different combinations of tilting or twisting types of loads (i.e., moment loads) and may possibly result in double contact on a lead nut. This double contact may lead to binding, jamming, and/or locking up the entire system, and may prevent the door from moving and/or result in damaged components.

The types of interfaces described above (e.g., between the carrier 178, 278 and the chain 154, 254, and/or between the carrier 178, 278 and the linkage 126, 226), may provide for much greater compliance than these traditional linear actuators. The carrier (e.g., the carrier 178, 278) may be guided completely by the track (e.g., the track 150, 250), and the risk of locking up this type of system may be significantly reduced from the traditional leadscrew design.

Some of the examples may be further described by reference to the following numbered clauses:

1. A chain drive comprising:
a housing defining a track;
a chain disposed at least partially within the housing, the chain having a first terminal end and a second terminal end;
a carrier configured to slide linearly along the track, wherein the first terminal end of the chain is coupled to the carrier and the second terminal end of the chain is coupled to the carrier, such that the chain and the carrier together form a closed loop;
an actuator coupled to the chain to drive rotation of the closed loop; and
a linkage having a first, proximal end coupled to the carrier and a second, distal end configured to be moved linearly toward and away from the housing via movement of the carrier along the track.

2. The chain drive of clause 1, wherein the first terminal end of the chain is spaced from the second terminal end of the chain by a gap.

3. The chain drive of clause 2, wherein the carrier includes an upper body, wherein the first terminal end of the chain is fixed to a first region of the upper body, and wherein the second terminal end of the chain is fixed to a second region of the upper body.

4. The chain drive of clause 3, wherein the carrier includes a lower body coupled to the upper body, wherein the lower body is positioned below the chain, and is positioned to slide along the track.

5. The chain drive of clause 4, wherein the chain, the carrier, and the track are sized and shaped such that the carrier is configured to have a limited rotational degree of freedom within the track.

6. The chain drive of any of the preceding clauses, wherein the carrier includes an upper plate and a lower plate spaced from the upper plate.

7. The chain drive of clause 6, further comprising a ball-shaped shaped interface member coupled to both the linkage and the carrier and positioned between the linkage and the carrier, wherein the ball-shaped interface member is configured to permit limited rotational movement of the linkage relative to the carrier.

8. The chain drive of clause 7, wherein the ball-shaped interface member is a rivet having a central, ball-shaped region, wherein the rivet includes an upper region that is fixed to upper plate and a lower region that is fixed to the lower plate.

9. The chain drive of any of the preceding clauses, wherein the actuator includes a motor and an over-molded sprocket coupled to the motor, wherein the chain extends around the sprocket and is configured to be driven by the motor and the sprocket.

10. A vehicle comprising:
a power swing door configured to pivot about an axis; and
the chain drive of any of the preceding clauses, wherein the second, distal end of the linkage is coupled to the power swing door to pivot the power swing door about the axis.

11. A chain drive comprising:
a housing defining a track;
a chain disposed at least partially within the housing;
a carrier coupled to the chain and configured to slide linearly along the track;
an actuator coupled to the chain to drive rotation of the chain;
a linkage having a first, proximal end coupled to the carrier and a second, distal end configured to be moved linearly toward and away from the housing via movement of the carrier along the track; and
a ball-shaped shaped interface member coupled to both the linkage and the carrier and positioned between the linkage and the carrier.

12. The chain drive of clause 11, wherein the ball-shaped interface member is configured to permit limited rotational movement of the linkage relative to the carrier.

13. The chain drive of clause 11 or clause 12, wherein the ball-shaped interface member is a rivet having a central, ball-shaped region, and wherein the linkage includes an aperture sized and shaped to receive the ball-shaped region.

14. The chain drive of clause 13, wherein the carrier includes an upper body fixed to the chain and a lower body coupled to the upper body and positioned to slide along the track.

15. The chain drive of clause 14, wherein the lower body includes an upper plate and a lower plate spaced from the upper plate, wherein the rivet includes an upper region that is fixed to upper plate and a lower region that is fixed to the lower plate.

16. The chain drive of clause 15, wherein the first, proximal end of the linkage includes the aperture.

17. The chain drive of clause 16, wherein the first, proximal end of the linkage is positioned between the upper plate and the lower plate.

18. The chain drive of clause 17, wherein a first gap extends between the upper plate and the first, proximal end of the linkage and a second gap extends between the lower plate and the first, proximal end of the linkage.

19. The chain drive of any of clauses 11-18, wherein the actuator includes a motor and an over-molded sprocket coupled to the motor, wherein the chain extends around the sprocket and is configured to be driven by the motor and the sprocket.

20. A vehicle comprising:
a power swing door configured to pivot about an axis; and
the chain drive of any of clauses 11-19, wherein the second, distal end of the linkage is coupled to the power swing door to pivot the power swing door about the axis.

Although the disclosure has been described in detail referring to certain preferred embodiments, variations and modifications exist within the scope and spirit of one or more independent aspects of the disclosure as described.

What is claimed is:

1. A chain drive comprising:
a housing defining a track;
a chain disposed at least partially within the housing, the chain having a first terminal end and a second terminal end;
a carrier configured to slide linearly along the track, wherein the first terminal end of the chain is coupled to the carrier and the second terminal end of the chain is coupled to the carrier, such that the chain and the carrier together form a closed loop;
an actuator coupled to the chain to drive rotation of the closed loop; and
a linkage having a first, proximal end coupled to the carrier and a second, distal end configured to be moved linearly toward and away from the housing via movement of the carrier along the track.

2. The chain drive of claim 1, wherein the first terminal end of the chain is spaced from the second terminal end of the chain by a gap.

3. The chain drive of claim 2, wherein the carrier includes an upper body, wherein the first terminal end of the chain is fixed to a first region of the upper body, and wherein the second terminal end of the chain is fixed to a second region of the upper body.

4. The chain drive of claim 3, wherein the carrier includes a lower body coupled to the upper body, wherein the lower body is positioned below the chain, and is positioned to slide along the track.

5. The chain drive of claim 4, wherein the chain, the carrier, and the track are sized and shaped such that the carrier is configured to have a limited rotational degree of freedom within the track.

6. The chain drive of claim 1, wherein the carrier includes an upper plate and a lower plate spaced from the upper plate.

7. The chain drive of claim 6, further comprising a ball-shaped interface member coupled to both the linkage and the carrier and positioned between the linkage and the carrier, wherein the ball-shaped interface member is configured to permit limited rotational movement of the linkage relative to the carrier.

8. The chain drive of claim 7, wherein the ball-shaped interface member is a rivet having a central, ball-shaped region, wherein the rivet includes an upper region that is fixed to upper plate and a lower region that is fixed to the lower plate.

9. The chain drive of claim 1, wherein the actuator includes a motor and an over-molded sprocket coupled to the motor, wherein the chain extends around the sprocket and is configured to be driven by the motor and the sprocket.

10. A vehicle comprising:
a power swing door configured to pivot about an axis; and
the chain drive of claim 1, wherein the second, distal end of the linkage is coupled to the power swing door to pivot the power swing door about the axis.

11. A chain drive comprising:
a housing defining a track;
a chain disposed at least partially within the housing;
a carrier coupled to the chain and configured to slide linearly along the track;
an actuator coupled to the chain to drive rotation of the chain;
a linkage having a first, proximal end coupled to the carrier and a second, distal end configured to be moved linearly toward and away from the housing via movement of the carrier along the track; and
a ball-shaped shaped interface member coupled to both the linkage and the carrier and positioned between the linkage and the carrier.

12. The chain drive of claim 11, wherein the ball-shaped interface member is configured to permit limited rotational movement of the linkage relative to the carrier.

13. The chain drive of claim 11, wherein the ball-shaped interface member is a rivet having a central, ball-shaped region, and wherein the linkage includes an aperture sized and shaped to receive the ball-shaped region.

14. The chain drive of claim 13, wherein the carrier includes an upper body fixed to the chain and a lower body coupled to the upper body and positioned to slide along the track.

15. The chain drive of claim 14, wherein the lower body includes an upper plate and a lower plate spaced from the upper plate, wherein the rivet includes an upper region that is fixed to upper plate and a lower region that is fixed to the lower plate.

16. The chain drive of claim 15, wherein the first, proximal end of the linkage includes the aperture.

17. The chain drive of claim 16, wherein the first, proximal end of the linkage is positioned between the upper plate and the lower plate.

18. The chain drive of claim 17, wherein a first gap extends between the upper plate and the first, proximal end of the linkage and a second gap extends between the lower plate and the first, proximal end of the linkage.

19. The chain drive of claim 11, wherein the actuator includes a motor and an over-molded sprocket coupled to the motor, wherein the chain extends around the sprocket and is configured to be driven by the motor and the sprocket.

20. A vehicle comprising:
a power swing door configured to pivot about an axis; and
the chain drive of claim 11, wherein the second, distal end of the linkage is coupled to the power swing door to pivot the power swing door about the axis.
